(19) United States
(12) Patent Application Publication
(10) Pub. No.: US 2009/0226030 A1
(43) Pub. Date: Sep. 10, 2009

(54) Coefficient modification for video watermarking

(76) Inventors: Jusitn Picard, Cologne (DE); Jian Zhao, North Attleboro, MA (US)

Correspondence Address: Thomson Licensing LLC, P.O. Box 5312, Two Independence Way, PRINCETON, NJ, 08543-5312, US

(21) Appl. No.: 11/990,574

(22) PCT Filed: Sep. 9, 2005
(86) PCT No.: PCT/US05/32384

§ 371 Date: Feb. 14, 2008

(51) Int. Cl. G06K 9/00

(52) U.S. Cl. 382/100

(57) ABSTRACT

A method and system for watermarking video images including generating a payload, selecting sets of coefficients, modifying coefficients and embedding said watermark by enforcing relationships between property values of selected sets of coefficients with a volume of video are described. The modified coefficients replace the selected sets of coefficients.

### FIELD OF THE INVENTION

The present invention relates to watermarking of video content and in particular to embedding and detecting watermarks in digital cinema applications.

### BACKGROUND OF THE INVENTION

Videos contain both a spatial and a temporal axis. Images (and similarly video frames) can be represented in the spatial domain or in a transform domain. In the spatial domain, also called the ‘baseband’ domain, images are represented as a grid of pixel values. The transform domain representation of a pixeled (i.e., discrete) image can be computed from a mathematical transformation of the spatial domain image. In general, this transformation is perfectly reversible, or at least reversible without significant loss of information. There are several transform domains, the most well-known being the FFT (Fast Fourier Transform), the DCT (Discrete Cosine Transform), which is used in the JPEG compression algorithm, and the DWT (Discrete Wavelet Transform), which is used in the JPEG2000 compression algorithm. One advantage of representing content in a transform domain is that the representation can generally be more compact than the baseband representation for a similar perceptual quality. Watermarking methods exist for embedding watermarks in the baseband as well as in a transform domain.

Video or video images lend themselves to various watermarking approaches. These approaches to video watermarking can be grouped into three categories, based on whether they select the spatial structure, the temporal structure, or the global three-dimensional structure of a video for watermarking.

Spatial video watermarking algorithms extend still image watermarking to video watermarking via frame-by-frame mark embedding with existing image watermarking algorithms. In the prior art, the frame-by-frame watermark is repeated in each frame on a certain interval, where the interval is arbitrary and can be a few frames up to the whole video. On the detector side, it is advantageous for the Power Signal-to-Noise Ratio (PSNR) to have the same watermark pattern repeated on a number of consecutive frames. However, if every frame has the same watermark pattern, special care may have to be taken to avoid vulnerability to a possible frame collusion attack. On the other hand, if the watermark changes for every frame, it can be harder to detect, while inducing flickering artefacts and still being vulnerable to collusion attacks in stable areas of the video.

As an improvement, it is not necessary to watermark every frame. In the prior art, only automatically selected ‘key frames’ (and the few frames around the key frame) are watermarked. Key frames are stable frames found between two boundary shots frames, and can be reliably located again even after a change of frame rate. Watermarking only key frames not only reduces the stress on the fidelity constraint but may also results in more security and less computational intensity.

While spatial domain watermarks can benefit from still image watermarking techniques robust to geometric transformations, e.g. using a geometrically invariant watermark, or replicating the watermark in tiled patterns or using a template in the Fourier domain, it is difficult to invert, notably due to the screen curvature and the geometric transformations that occur during a camcorder capture of a projected movie. Furthermore, these two approaches are not secure against signal processing attacks, for instance, a template in the Fourier domain can easily be removed. Therefore, spatial domain watermarks can be more easily and securely detected if the original content is used for registration. In the prior art, a semi-automated registration method is used that matches feature points in the original frame with feature points in the extracted frame. For projection on a flat screen, a minimum of four reference points must be matched for inverting the transformation. An operator manually selects at least four feature points from a set of pre-computed feature points. A two-level registration can be done entirely automatically: first in the temporal domain, then in the spatial domain. A database of frame signatures (also called fingerprints, soft hash or message digest) is accessed by the watermark detector to match an extracted key frame with the corresponding original frame. The latter is then used for automatic spatial registration of the test frame.

It should be noted, however, that the computations for the selection of key frames require upcoming frames, which are not available at the time of watermark embedding for a real time application. An alternative method would be to maintain a constant time delay between frame processing and playback.

Prior art temporal watermarking schemes only exploit the temporal axis to insert a watermark, by varying the global luminance in each frame. That makes the watermark inherently robust to geometrical distortions, as well as simplifying the watermark reading after a camcorder attack. The robustness of the watermark to temporal low-pass filtering (typically applied when de-flickering a camcorded video) can be improved with other methods known in the art. However, the watermark can be fragile to temporal de-synchronization (especially after frame editing). Synchronization, however, can also be recovered by matching key frames between the desynchronized and original video.

The two previous approaches (spatial or temporal watermarking) use either one or two of the three available dimensions for watermarking. The absence of watermark structure in one or two of the three available dimensions in a video results in a suboptimal use of the space available for a watermark. The method described in Bloom et al., U.S. Pat. No. 6,885,757 “Method and Apparatus for Providing an Asymmetric Watermark Carrier” makes complete use of the structure of a video. In their spread-spectrum method, the technique is apparently robust and secure but the detector must synchronize the test video with the original video prior to detection.

### SUMMARY OF THE INVENTION

An aspect of the present invention involves pseudo-randomly inserting constraint-based relationships between or among property values of certain coefficients over consecutive frames or within a single frame. The relationships encode the watermark information.

‘Coefficients’ are denoted as the set of data elements, which contain the video, image or audio data. The term ‘content’ will be used as a generic term denoting any set of data elements. If the content is in the baseband domain, the coefficients will be denoted ‘baseband coefficients’. If the content is in the transform domain, the coefficients will be denoted as ‘transform coefficients’. For example, if an image, or each frame of a video, is represented in the spatial domain, the pixels are the image coefficients. If an image frame is represented in a transform domain, the values of the transformed image are the image coefficients.

The present invention in particularly deals with DWT for JPEG200 images in digital cinema applications. The DWT of a pixeled image is computed by the successive application of vertical and horizontal, low-pass and high-pass filters to the image pixels, where the resulting values are called ‘wavelet coefficients’. A wavelet is an oscillating waveform that persists for only one or a few cycles. At each iteration, the low-pass only filtered wavelet coefficients of the previous iteration are decimated, then go through a low-pass vertical filter and a high-pass vertical filter, and the results of this process are passed through a low-pass horizontal and a high-pass horizontal filter. The resulting set of coefficients is grouped in four ‘subbands’, namely the LL, LH, HL and HH subbands.

In other words, the LL, LH, HL and HH coefficients are the coefficients resulting from the successive application to the image of, respectively, low-pass vertical/low pass horizontal filters, low-pass vertical/high-pass horizontal filters, high-pass vertical/low-pass horizontal filters, high-pass vertical/high-pass horizontal filter.

An image may have a number of channels (or components), that correspond to different native colors. If the image is in grayscale, then it has only one channel representing the luminance component. In general, the image is in color, in which case three channels are typically used to represent the different color components (though a different number of channels is sometimes used). The three channels may respectively represent the red, green and blue component, in which case the image is represented in the RGB color space, however, many other color spaces can be used. If the image has multiple channels, the DWT is generally computed separately on each color channel.

Each iteration corresponds to a certain ‘layer’ or ‘level’ of coefficients. The first layer of coefficients corresponds to the highest resolution level of the image, while the last layer corresponds to the lowest resolution level. FIG. 1 is a video representation in one component of a 5-level wavelet transform. Units 105-120 are frames of a video. Unit 125 indicates the LL subband coefficients at the lowest resolution. Unit 125a shows the coefficients at (f,c,l,b,x,y) with frame f=0, channel c=0, subband b=0, resolution level 1=0, and positions x and y=0.

To best exploit the 3D structure of a video, the present invention uses both the temporal and spatial axis. As spatial registration is hard to achieve for movies after projection and capture, the present invention uses very low spatial frequencies or global properties of low spatial frequencies, which are less sensitive to geometric distortions for spatial registrations. Temporal frequencies are more easily recovered as most transforms occurring during attacks are time-linear.

In the present invention, the low-resolution wavelet coefficients of the video are directly watermarked. As the number of pixels in a frame is on the order of 1000 times larger than the number of the lowest resolution wavelet coefficients, the number of operations is potentially much smaller in the present invention.

A method and system for watermarking video images including generating a watermark and embedding the generated watermark into video images by enforcing relationships between property values of selected sets of coefficients with a volume of video are described. The watermarks are thereby adaptively embedded in the volume of video. A method and system for watermarking video images including selecting sets of coefficients and enforcing relationships between property values of selected sets of coefficients with a volume of video are also described. A method and system for watermarking video images including generating a payload, selecting sets of coefficients, modifying coefficients and embedding said watermark by enforcing relationships between property values of selected sets of coefficients with a volume of video are also described. The modified coefficients replace the selected sets of coefficients

A method and system for detecting watermarks in video images including preparing a signal, extracting and calculating property values, detecting bit values and decoding a payload, where the payload is a bit sequence generated and embedded by enforcing relationships between property values in a volume of video are described. A method and system for detecting watermarks in video images including preparing a signal and decoding a payload, where the payload is a bit sequence generated and embedded by enforcing relationships between property values in a volume of video are also described. A method and system for detecting watermarks in a volume of video including preparing a signal, extracting and calculating property values and detecting bit values are also described.

While the present invention may be implemented in hardware, firmware, FPGAs, ASICs or the like, it is best implemented in software residing in a computer or processing device where the device may be a server, a mobile device or any equivalent thereof. The method is best implemented/performed by programming the steps and storing the program on computer readable media. In the event that the speed required for real-time processing requires hardware for one of more sequences of steps, a hardware solution for all or any part of the processes and methods described herein can be easily implemented with no loss of generality. The hardware solution can be then be embedded into a computer or processing device, such as but without limitation a server or mobile device. In an example of implementation for real-time watermarking JPEG2000 images for digital cinema application, a JPEG2000 decoder in a digital cinema server or projector delivers the coefficients of the lowest resolution level of each frame to the watermarking embedding module. The embedding module modifies the received coefficients and returns them to the decoder for further decoding. The delivery, watermarking and return of coefficients are performed in real-time.

### BRIEF DESCRIPTION OF THE DRAWINGS

The present invention is best understood from the following detailed description when read in conjunction with the accompanying drawings. The drawings include the following figures briefly described below where like-numbers on the figures represent similar elements:

FIG. 1 is a video representation in one component of a 5-level wavelet transform.

FIG. 2 is a flowchart depicting the payload generation step of watermarking.

FIG. 3 is a flowchart depicting the coefficient selection step of watermarking.

FIG. 4 is a flowchart depicting the coefficient modification step of watermarking.

FIG. 5 shows a video frame at full resolution and a video frame reconstructed from coefficients at resolution level 5.

FIG. 6 is a block diagram of watermarking in a D-cinema server (Media Block).

FIG. 7 is a flowchart depicting video watermark detection.

FIG. 8 is a flowchart depicting signal preparation for video watermark detection.

FIG. 9 shows a cross-correlation function.

FIG. 10 is a flowchart depicting detection of bit values in video watermark detection.

FIG. 11 shows an accumulated signal.

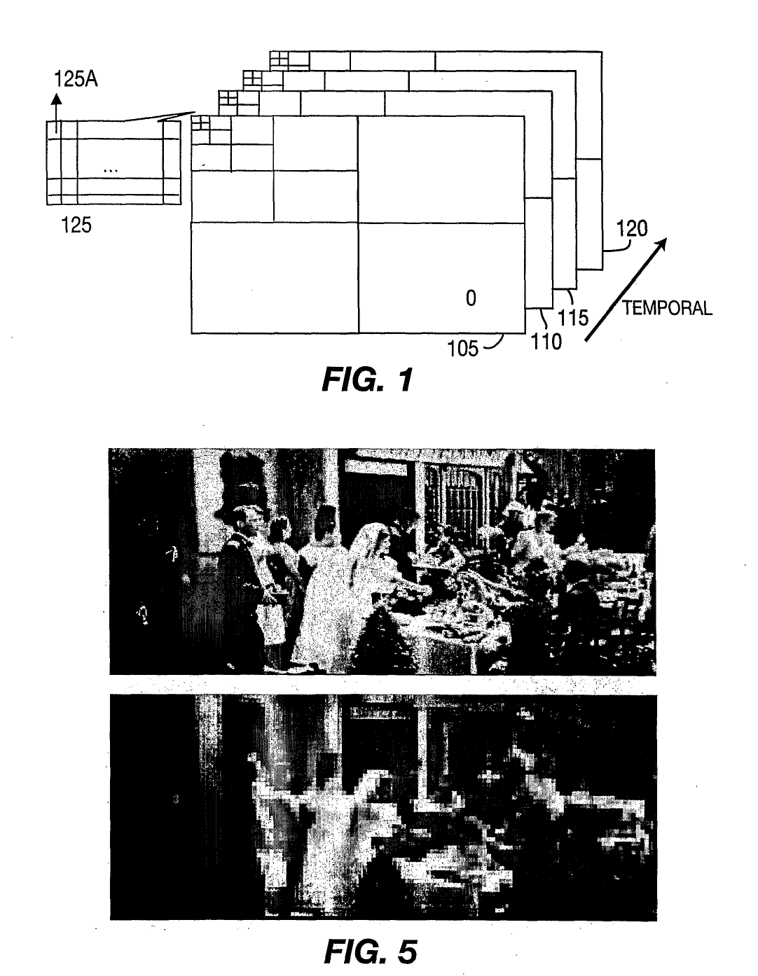

### DETAILED DESCRIPTION OF THE PREFERRED EMBODIMENTS

A number of applications require real-time watermark embedding such as session-based watermark embedding for Set-Top Box and for Digital Cinema Server (or called Media Block) or Projector. While fairly obvious, it is worth mentioning that this renders it difficult to apply watermarking methods that, at a given time, exploit frames coming later in time. Offline pre-computations (for example of a watermark's location or strength) should preferably be avoided. There are several reasons for that, but the two most important ones are: potential security leaks (current generation watermarking algorithms are generally less secure if the attacker knows the full details of the embedding algorithm), and impracticality.

In most applications, a unit of digitally watermarked content generally undergoes some modification between the time it is embedded and the time it is detected. These modifications are named ‘attacks’ because they generally degrade the watermark and render its detection more difficult. If the attack is expected to occur naturally during the application, the attack is considered ‘non-intentional’. Examples of non-intentional attacks can be: (1) a watermarked image that is cropped, scaled, JPEG compressed, filtered etc. (2) a watermarked video that is converted to NTSC/PAL SECAM for viewing on a television display, MPEG or DIVX compressed, re-sampled etc. On the other hand, if the attack is deliberately done with the intention of removing the watermark or impairing its detection (i.e. the watermark is still in the content but cannot be retrieved by the detector), then the attack is ‘intentional’, and the party performing the attack is the ‘pirate’. Intentional attacks generally have the goal to maximize the chance of making the watermark unreadable, while minimizing the perceptual damage to the content: examples of attacks can be small, imperceptible combinations of line removals/additions and/or local rotation/scaling applied to the content to make very difficult its synchronization with the detector (most watermark detectors are sensitive to de-synchronization). Tools exist on the internet for the above attack purposes, e.g. Stirmark (http://www.petitcolas.net/fabien/watemarking/stirmark/).

In the case of the so-called ‘camcorder attack’, which is performed by a person illegally capturing a movie during playback in a theater, the attack is considered unintentional, even if the party performs an illegal action. Indeed, the movie capture is not done with the intent of removing the watermark. However, after its capture, the person may run additional processes on the captured video to ensure that the watermark can no longer be detected in the content. These latter attacks are then considered intentional.

For example, a session-based watermark for digital cinema must survive the following attacks: resizing, letterboxing, aperture control, low-pass filtering and anti-aliasing, brick wall filtering, digital video noise reduction filtering, frame-swapping, compression, scaling, cropping, overwriting, the addition of noise and other transformations.

Camcorder attacks include the following attacks in sequential order: camcorder capture, de-interlacing, cropping, de-flickering and compression. Notably, camcorder capture introduces a significant spatial distortion. The present invention is focused on the camcorder attack because it is generally recognized that a watermark surviving the camcorder attack will survive most other non-intentional attacks, e.g. a screener copy, telecine, etc. However, it is important as well that the watermark survives other attacks. The frames of a video are generally interlaced for playing on NTSC or PAL SECAM compliant systems. De-interlacing, does not really impact the detection performance, but is a standard process used by pirates to improve the captured video quality. A video of aspect ratio 2.39 is captured fully with approximately a 4:3 aspect ratio; the top and bottom areas of the video are roughly cropped. Captured videos typically exhibit a disturbing flicker, which is due to an aliasing effect in the time domain. The flicker corresponds to quick variation of luminance, which can be filtered out. De-flickering filters are often used by pirates to remove such flickering effects. Even if de-flickering filters are not used with the intention of erasing a watermark, they can be very damaging to the temporal structure of the watermark, because they strongly low pass filter each frame. Finally, captured movies are compressed to fit the available distribution bandwidth/media/format, e.g. DIVX or other lossy video formats. For example, movies found on P2P networks often have a file size allowing for storing an entire 100 minute movie on a 700 Mbytes CD. This corresponds to an approximate total bit rate of 934 kbps, or about 800 kbps if 128 kbps are kept for the audio tracks.

This sequence of attacks corresponds to the most severe processes that would occur during the lifetime of a pirated video that can be found on a peer-to-peer (P2P) network. It also includes, explicitly or implicitly, most of the above-mentioned attacks that watermarks must survive. In addition to the camcorder attack, the watermarking method and apparatus of the present invention also survives frame-editing (removal and/or addition) attacks.

Watermarking detection systems are called ‘blind’ (or non-blind) if the detector does not need (does need) access to the original content. There are also so called semi-blind systems that need access only to data derived from the original content. Some applications such as forensic tracking for session-based watermarks for digital cinema do not explicitly require a blind watermark solution and access to original content is possible as detection will typically be done offline. The present invention uses a blind detector but inserts synchronization bits in order to synchronize the content at the detector. Semi-blind detectors can also be used with the present invention. If a semi-blind detector is used, synchronization could eventually be performed using the data derived from the original content. In this case, the synchronization bits would not be necessary, and the size of the watermark, also called watermark chip, could be reduced.

In a specific example for digital cinema application, a minimum payload of 35 bits needs to be embedded in the content. This payload should contain a 16-bit timestamp. If a time stamp is generated every 15 minutes (four per hour), 24 hours per day and 366 days/year, and the stamp repeats annually, there are 35,136 time stamps needed, which can be represented with 16 bits. The other 19 bits can be used to represent a location or serial number for a total 524,000 possible locations/serial numbers.

In addition, all 35-bits are required to be detectable from a five minute segment. In other words, no more than 5 minutes of video should be required to extract the forensic mark.

In one embodiment, the present invention uses a 64-bit watermark, and the watermark chip is repeated every 3:03 minutes. A video watermark chip embedded in 3:03 minutes of video at 24 frames per second with one embedded bit per frame has 4392 bits (183 seconds*24 frames per second=4392 frames=4392 bits at one bit per frame).

The video watermarking method of the present invention is based on modifying the relationship between different properties of the content. Specifically, to encode bits of information, certain coefficients of an image/video are selected, assigned to different sets, and manipulated in a minimal way in order to introduce a relationship between the property values of the different sets. Sets of coefficients have different property values, which generally vary in different spatio-temporal regions of a video, or are modified after processing the content. In general, the present invention uses property values that vary in a monotonic way, for which attacks have a predictable impact, because it is easier to ensure a robust relationship in that case. Such properties will be denoted as ‘invariant’. While the present invention is best practiced using invariant properties, it is not so limited and can be practiced using properties that are not invariant. For example, the average luminance value of a frame is considered ‘invariant’ over time: it varies generally in a slow, monotonic way (except at boundary shots); furthermore, an attack such as contrast enhancement will generally respect the relative ordering of each frame's luminance value.

A video content is typically represented with multiple separate components (or channels) such as RGB (red/green/blue, widely used in computer graphics and color television), YIQ, YUV and YCrCb (used in broadcast and television). YCrCb consists of two major components: luminance (Y) and chrominance (CrCb or also known as UV). The amount of luminance or Y-component of a video content indicates its brightness. Chrominance (or chroma) describes the color portion of the video content, which includes the hue and saturation information. Hue indicates the color tint of an image. Saturation describes the condition where the output color is constant, regardless of changes in the input parameters. The chrominance components of YCrCb include the color-red (Cr) component and the color-blue (Cb) of the color. The present invention considers a video content as multiple 3D volumes of coefficients with the size of W*H*N (where W, H are the width, height of a frame in the baseband domain or in a transform domain, respectively, and N is the number of frames of the video). Each 3D volume corresponds to one component representation of a video content. The watermark information is inserted by enforcing constraint-based relationships between certain property values of selected sets of coefficients within one or more volumes. However, as the human eye is much less sensitive to the overall intensity (luminance) changes than to color (chrominance) changes, a watermark is preferably embedded in the 3D video volume representing the luminance component of a video content. Another advantage of luminance is that it is more invariant to transformations of the video. Hereinafter, a 3D video volume represents the luminance component unless otherwise specified, although it can represent any component.

In the present invention, a set of coefficients can contain any number of coefficients (from one to W*H*N) taken from arbitrary locations in the content. Each coefficient has a value. Therefore different property values can be computed from a set of coefficients—some examples are given below. To insert the watermark information, a number of relationships can be enforced by varying the coefficient values in a number of sets of coefficients. A relationship is to be understood in a non-limiting way, as one or a set of conditions that one or more property values of one or more sets of coefficients must satisfy.

Various types of properties can be defined for each set of coefficients. Properties are calculated preferably in the baseband domain (such as brightness, contrast, luminance, edge, color histogram) or in transform domain (energy in a frequency band). Some property values can be calculated equally in the baseband and transform domains, as is the case of luminance.

One suitable way to embed a bit of information is by selecting two sets of coefficients, and enforcing a pre-defined relationship between their property values. The relationship can be, for instance, that one property value of the first set of coefficients is greater than the corresponding property value of the second set of coefficients. However, it is noted that there are several variations in the ways to embed bits of information. One way to embed more than one bit of information in the two selected sets of coefficients is to enforce relationships between the values of more than one property of the two sets of coefficients.

It is also possible to embed a bit of information by using only one set of coefficients, and enforcing a relationship of a property value of this set of coefficients. For instance, the property value can be set to be greater than a certain value, which may be predefined or adaptively computed from the content. It is also possible to embed more than two bits of information using one set of coefficients, by defining four exclusive intervals, and enforcing the condition that the property value lies in a certain interval. Other ways to embed more than one bit include using more than one property value, and enforcing a relationship for each of the property values.

In general, the basic scheme can be generalized to an arbitrary number of sets of coefficients, an arbitrary number of property values and an arbitrary number of relationships to be enforced. While this can be advantageous to embed higher quantities of information, specific techniques such as linear programming may have to be used in order to ensure that the various relationships are enforced simultaneously with a minimal perceptual change. As noted above, it can be easier to enforce a relationship if invariant property values are used.

Many properties in a 3D video volume (and set of coefficients) are relatively invariant in a spatio-temporal way and/or before/after processing of the content. Examples of invariant properties include:
Coefficients (e.g. wavelet coefficients) in consecutive frames or different sub-bands of the same frame
Average luminance values in consecutive frames
Average texture feature value in consecutive frames
Average edge measure in consecutive frames
Average color or luminance histogram distribution in consecutive frames.
Energy in a certain frequency range
Any of the above invariant properties in an area defined by extracted feature points

Watermarking algorithms generally operate with a secret ‘key’, which is known only to the embedder and detector. Using a secret key brings similar advantages as in cryptographic systems: for instance, the details of the watermarking system can be, in general, known without compromising the security of the system, therefore algorithms can be disclosed for peer review and potential improvement. Furthermore, the secret of the watermarking system is held in a key, i.e. one can only embed and/or detect the watermark if the key is known. Keys can more easily be hidden and transmitted because of its compact size (typically 128 bits). A symmetric key is used to pseudo-randomize certain aspects of the algorithm. Typically, the key is used to encrypt the payload (e.g. using a standard cryptographic algorithm such as DES) after it has been encoded for error correction and detection, and expanded to fit the content. For the method of the present invention, the key can also be used to set the relationships, which will be inserted between the property values of two different sets of coefficients. Therefore, these relationships are considered to be ‘pre-defined’, as they are fixed for a given secret key. If there is more than one pre-defined relationship for embedding the watermark, the key can also be used to randomly select the precise relationship, for a given bit of information and given sets of coefficients.

The selected sets of coefficients generally correspond to ‘regions’, where a region is to be understood as a set of coefficients located in the same area of the content. While regions of coefficients may correspond to spatio-temporal regions of the content, as is the case of baseband coefficients and wavelet coefficients, it is not necessarily the case. For instance, the 3D Fourier transform coefficients of the content correspond to neither a spatial nor a temporal region, but it would correspond to a region of similar frequencies.

For example, a set of coefficients may correspond to a region, which can be made of all the coefficients in a certain spatial area for one frame. To encode a bit of information, two regions from two consecutive frames are selected and their corresponding coefficient values are modified to enforce a relationship between certain properties of these two regions. It is noted, as will be explained in further detail below, that it may not be necessary to modify the coefficient values if the desired relationship already exists.

For yet another example, with wavelet transform there are four wavelet coefficients (LL, LH, HL and HH) corresponding to the four subbands for each position and each component (channel) at each resolution level for each frame. A set of coefficients may just contain one coefficient in one of the four subbands. Assume that C1, C2, C3, C4 are the four coefficients located at the same position, channel and resolution level but in four subbands, respectively. One method to embed watermark is to enforce a relationship between C2 and C3, which corresponds to the coefficients in HL and LH subbands, respectively. One example of the relationship is that C2 is greater than C3. Another method to embed watermarks is to enforce relationships between C1-C4 in a frame and the corresponding coefficients in the consecutive frame. A variation on this principle is by inserting a relationship for only one type of coefficient, where the coefficient must be greater than a pre-computed value. For instance, for all positions in a frame at a certain resolution level it is possible to enforce a constraint that the value of coefficient LL is greater than a pre-computed value. In the above examples, the property value is the value of a wavelet coefficient itself.

It is essential to be able to identify the same, or nearly the same sets of coefficients on the detection side as on the watermarking side. Otherwise, the wrong coefficients would be selected and the measured property value would be erroneous. Identifying the correct coefficients is generally not a problem if the content has been mildly processed before detection, in which case the location of the coefficients (whether in a spatial or transform domain) has not changed. However, if the processing changes the geometrical or temporal structure of the content, as is generally the case during a camcorder attack, the coefficients are likely to change location.

If there is a change in the temporal structure of the content, one can either use a non-blind or semi-blind scheme, to resynchronize the content. Different methods are available in the prior art for that purpose. If the detection must be done blindly (i.e. without access to any data derived from the original content) it is possible to insert synchronization bits with a predictable value in the content, which will be used by the detector for resynchronizing the content. Such a scheme will be described in further detail below.

To ensure robustness to changes in the geometrical structure of the content, synchronization/registration methods, known in the prior art, which restore the modified content by matching the locations in the modified content to the corresponding location in the original content can be used. Changes in the geometrical structure of the content occur, for example, after rotation, scaling and/or cropping of the content in the case where the original content, or where some data derived from it are available (e.g. a thumbnail or some characteristic information of the original content),

In the case of blind detection, one possibility is to use very low spatial frequencies. For a video frame or an image, one region of coefficients may correspond to a full video frame, a half or a quarter of the frame. In this case, most of the coefficients will be correctly selected (all coefficients, if the region corresponds to a full video frame), and the detection is generally robust even if some coefficients are assigned to the wrong set.

Another way to be inherently robust to a change in the geometrical structure is to use regions that actually contain only one coefficient, and to enforce a relationship between one coefficient in one frame and one coefficient at the corresponding position in the next frame. If the same relationship is enforced for all coefficients in the two frames, one can easily see that the detection is inherently robust to geometrical distortions. A related way to ensure robustness to a change in geometrical structure is to create relationships between the different wavelet coefficients at a given location in different sub-bands. For example, in wavelet transform there are four coefficients corresponding to the four subbands (LL, LH, HL and HH) for each resolution level, each position and component (channel). The same relationship between two coefficients for all positions in a frame may be enforced at a certain resolution level to embed a watermark bit for strengthening the watermark robustness. On the detection side, the number of times that the relationship is observed as an indicator of which bit was embedded.

Yet another way to ensure robustness to changes in the geometrical structure is to use feature points that are invariant to changes in the geometrical structure. Here, invariant means when, using a certain algorithm to extract feature points of a video or image, the same points are found on the original and on the modified content. Different methods are known in the prior art for that purpose. Those feature points can be used to delimit the regions of coefficients in the baseband and/or transform domain. For example, three adjacent feature points delimit an internal region, which can correspond to a set of coefficients. Also, three adjacent feature points can be used to define sub-regions, with each sub-region corresponding to a set of coefficients.

Yet another way to be inherently robust to a change in the geometrical structure is to enforce the relationships between the value of a global property of all coefficients in one frame and the value of the same global property of all coefficients in a second frame. It is assumed such global property is invariant to the change in the geometrical structure. An example of such global property is the average luminance value of one image frame.

A non-limiting exemplary algorithm that embeds bits by enforcing constraints between property values of two consecutive frames of a video is as follows:

For each frame which is a JPEG2000 compressed image in a sequence of frames F1, F2, . . . Fn of video:
a) Select a region, which consists of N coefficients at the resolution level L. The coefficients may belong to one or more subbands, such as LL, LH, HL and HH. The region can be of arbitrary but fixed shape (e.g. rectangle shape) or as described above can vary depending on the original image content, using for example feature points for additional stability of the region when facing geometric attacks.
b) Determine the relevant global property for the region. A global property may be an average luminance value, an average texture feature measure, an average edge measure, or an average histogram distribution of the region. P is the value of such a global property.
   For embedding a bit sequence {b1, b2, . . . bm}:
a) If bi (1≦i≦m) is 0, modify F_{2*i} and F_{2*i+1} in a minimal way (only if necessary) such that P(F_{2*i+1})>P(F_{2*i}).
b) Else If bi (1≦i≦m) is 1, modify F_{2*i} and F_{2*i+1} in a minimal way (only if necessary) such that P(F_{2*i+1})<P(F_{2*i}).

This algorithm can be extended to embed multiple bits per frame, by inserting relationships between several property values of the two frames.

For watermark detection:
a) Synchronize the captured video in the temporal domain. This can be done either using synchronization bits, a non-blind or semi-blind scheme.
b) Select a region which consists of N coefficients at the level L. Similarly to embedding, the region can be of fixed shape.
c) Calculate the relevant global property for the region. P′ is the value of the global property of the region.
d) A bit 0 is detected if P′(F_{2*i+1})>P′(F_{2*i})
   e) A bit 1 is detected if P′(F_{2*i+1})<P′(F_{2*i})

Watermarking in the present invention is separated into three steps: payload generation, coefficient selection, and coefficient modification. The three steps are described in detail below as an exemplary embodiment of the present invention. It should be noted that a great deal of variation is possible for each of these steps, and the steps and the description are not intended to be limiting.

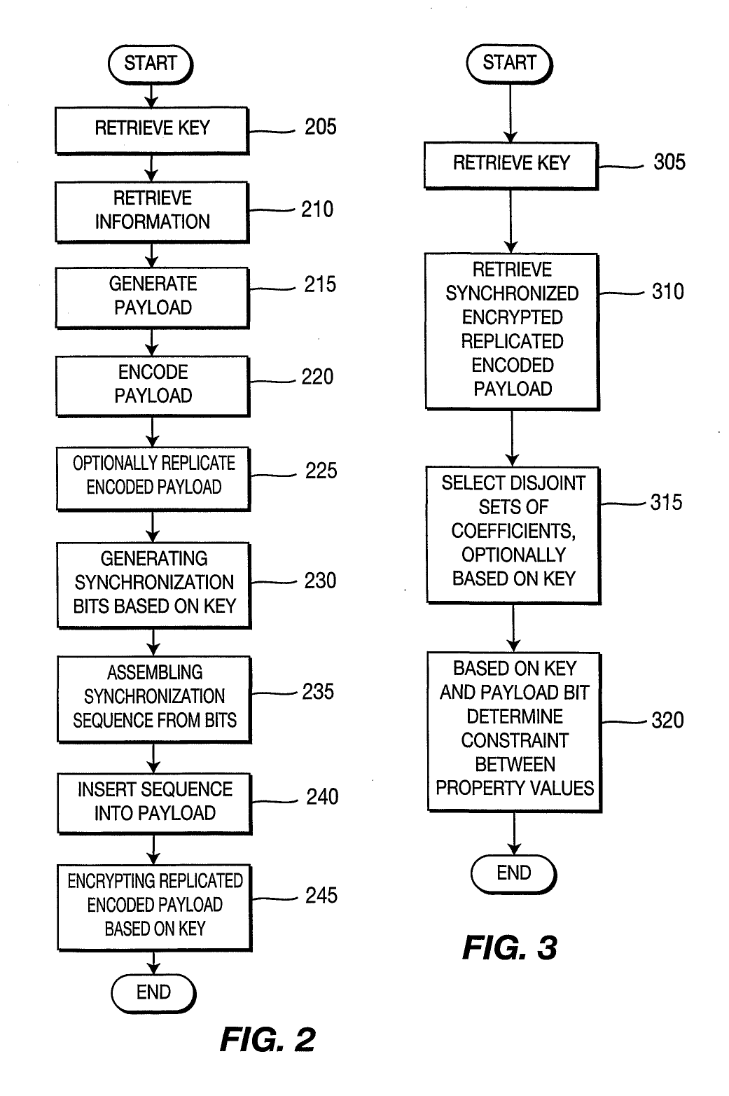

Referring now to FIG. 2, which is a flowchart depicting the payload generation step of watermarking, a secret key is retrieved or received in step 205. Information including a time stamp and a number identifying a location or serial number of a device are retrieved or received at step 210. The payload is generated at step 215. The payload for a digital cinema application is a minimum of 35 bits and in a preferred embodiment of the present invention is 64 bits. The payload is then encoded for error correction and detection, for example, using BCH coding at step 220. The encoded payload is optionally replicated at step 225. Optionally, then synchronization bits are generated based on the key at step 230. Synchronization bits are generated and used when using blind detection. They may also be generated and used when using semi-blind and non-blind detection schemes. If synchronization bits were generated then they are assembled into a sequence at step 235. The sequence is inserted into the payload at step 240 and the entire payload is then encrypted at step 245.

Payload generation includes translating the concrete information to be embedded into a sequence of bits, which we call the “payload”. The payload to be embedded is then expanded through the addition of error correction and detection capabilities, synchronization sequences, encryption and potential repetitions depending on the available space. An exemplary sequence of operations for payload generation is:
1. Translate “information” to be embedded into an “original payload”. Transform information (timestamp, projector ID, etc.) into payload. An example was given above for creating a 35 bit payload for a digital cinema application. In an exemplary embodiment of the present invention, the payload has 64 bits. Compute “encoded payload” from original payload, the encoded payload includes error correction and detection capabilities. Various error correction codes/methods/schemes can be used. For example, BCH coding. The BCH code (64,127) can correct up to 10 errors in the received bit stream (i.e. approximately 7.87% error correction rate). However, if the encoded payload is repeated a number times, a greater number of errors can be corrected thanks to the redundancy. In an exemplary embodiment of the present invention, the 127-bit repeated encoded payload is repeated 12 times, and it is possible to correct up to 30% errors in the individual bits embedded in each frame.
2. Depending on available space, replicate the encoded payload to obtain “replicate encoded payload”. In the present invention, replicate each of the encoded bits twelve times for a total of 127 (BCH coding)*12=1524 bits.
3. Using a key, encrypt the replicated encoded payload; to obtain “encrypted payload”; the encrypted payload is typically the same size as the replicated encoded payload.
4. (Optionally, prior to encryption) Generate synchronization bits and insert at various places in the repeated encoded payload; the resulting sequence is the video watermark payload. For example, compute a fixed synchronization sequence with 2868 bits. This sequence is split into one global synchronization unit of 996 bits (as the header of the watermark chip) and 12 local synchronization units of 156 bits (for the headers of each payload). In this example, a large number of bits are used as synchronization bits. While it is possible to reduce the amount of synchronization bits significantly if we were to use a non-blind method (wherein the original content is used for temporally synchronizing the test content) at the detector, the synchronization bits are still very useful for locally adjusting registration. In other words, synchronization bits do take space that could be otherwise used for additional redundancy of the information and thereby increase robustness to individual bit errors. However, synchronization bits increase the precision and quality of the extracted information, which results in less individual bit errors. The number of inserted synchronization of bits is therefore set as the best compromise resulting in the smallest number of errors in the 127 encoded bits.
5. Assemble the watermark chip by concatenating the following bits in order:
   Global synchronization (996 bits) synchronization unit.
   First 127 bits of encrypted payload, then first local synchronization unit (156 bits)
   Second 127 bits of encrypted payload, then second local synchronization unit (156 bits)
   . . .
   Last 127 bits of payload, then last local synchronization unit (156 bits)

The watermark chip (e.g., 4392 bits) is typically a few orders of magnitude larger than the original payload (e.g., 64 bits). This allows recovery from the errors that occur during transmission on a noisy channel.

Referring now to FIG. 3, which is a flowchart depicting the selection of coefficients for watermarking, the key is retrieved or received at step 305. The payload (encrypted, synchronized, replicated and encoded) is retrieved at step 310. The coefficients are then divided into disjoint sets based on the key at step 315. Based on the payload bit and the key, the constraint between property values is determined at step 320.

The selection of coefficients can occur in the baseband or in a transform domain. The coefficients in a transform domain are selected and grouped in two disjoint sets C1 and C2. A key is used to randomize the coefficient selection. A property value for each of the two sets, P(C1) and P(C2) is identified, such that it is generally invariant for C1 and C2. A variety of such properties can be identified, for example, average value (e.g. luminance), maximum value, and entropy.

The key and bit to be inserted are used to establish the relationship between the values of a property of C1 and C2, for instance P(C1)>P(C2). This is called constraint determination. For additional robustness, a positive value ‘r’ can be used such that P(C1)>P(C2)+r. The relationship may already be in place, in which case the coefficients need not be modified. In the worst case, P(C2) may be significantly larger than P(C1), for instance, if P(C2) is already greater than P(C1)+t where t is a pre-determined value or determined according to a perceptual model, in which case it is not worth changing the coefficients because it may introduce perceptual damage. In most cases though, P(C1) will become P′ 1=P(C1)+p1, and P(C2) will become P′2=P(C2)−p2 (p1 and p2 are positive numbers), such that P′1>P′2+r.

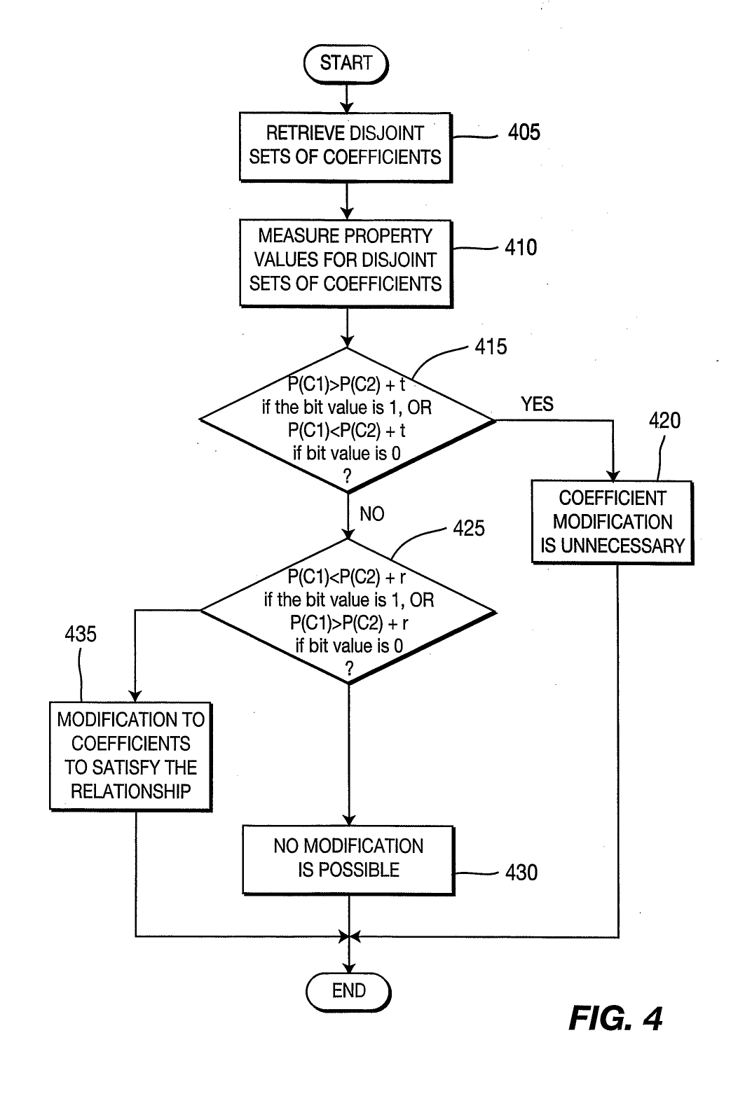

Referring now to FIG. 4, which is a flowchart depicting the coefficient modification step of watermarking, at step 405, the disjoint sets of coefficients are received or retrieved. The property values for the disjoint sets of coefficients are measured at step 410. The property values are tested at step 415 to determine the distance between them, which is a measure of the robustness. If the property values are within a threshold distance, t, then proceed to step 420 because no coefficient modification is necessary. If the property values are greater than the threshold distance, r, then a further test is performed at step 425 to determine if the property values are within certain maximum distances allowed in order to perform coefficient modification. If the property values are within the maximum distances then the coefficients are modified to satisfy the constraint relationship at step 435. If the property values are not within the maximum distances then the coefficients are not modified as prescribed by step 430.

The watermarking method of the present invention is “adaptive” to the original content, because the modifications to the content are minimal while ensuring that the bit value will be correctly detected. Spread spectrum watermarking methods can be also adaptive to the original content, but in a different way. Spread spectrum watermarking methods take account of the original content to modulate the change such that it does not lead to perceptual damage. This is conceptually different from the method of the present invention, which may decide not to insert any change at all in certain areas of the content, not because such modifications would be perceptible, but because the desired relationship already exists or because the desired relationship cannot be set without significantly deteriorating the content. As will be seen below, the method of the present invention can, however, be made adaptive both for ensuring that that the bit will be correctly decoded and to minimize the perceptual damage.

Because the method of the present invention introduces a minimal amount of distortion to ensure that a bit is robustly embedded, and gives up in cases where the distortion would be too severe, it would lead to a greater robustness than the spread spectrum methods for the same distortion and bit rate.

In the baseband domain, one embodiment of the present invention divides the pixels in each frame into a top part and a lower part. The luminance of the top/lower part is increased or decreased depending on the bit to be embedded. Each frame is split into four rectangles in the spatial domain from the center point. Splitting the frame into four rectangles allows storage of up to four bits per frame. The method includes:
Grouping pixel values into top part of a frame and lower part of a frame, to form two sets of coefficients C1 and C2.
Measuring the luminance, i.e. P(C1) is the average of all coefficients in C1, and same for C2.
Modifying the pixel values only if required, and in a minimal way to set the constraint, e.g. P(C1)>P(C2)+r, where r is generally a positive value.

In this embodiment of the present invention, the watermark embedding module only has access to the lowest resolution coefficients of the wavelet transformation of the image. For video frames with pixel size 2048 (width)×856 (height) pixels, there are 64×28=1728 coefficients for each subband at resolution level 5 (i.e. LL, LH, HL and HH), or 1728*4=6912. Only these coefficients, or a subset of these coefficients, are used for video watermark embedding. Two non-limiting methods are described below using groups of coefficients selected within a frame.

In the first method, only the LL coefficients (also called approximation coefficients) are used for video watermark embedding. The LL coefficient matrix (64×28) is split into four tiles/parts from the center point. C1, C2, C3 and C4 of 32×14 each. Depending on the bit to be embedded and the key, a certain relationship is created between the coefficients of each of the four parts LLa (top left region), LLb (top right), LLc (bottom right) and LLd (bottom left) by increasing/decreasing coefficients of each part such that a certain constraint is met. Each of the four rectangular tiles/parts can have between 286 and 1728 coefficients for each of the three color channels. To smoothen the watermark (and limit its visibility) at the transition between regions LLa to LLd, a transition region can be left non-watermarked or watermarked with a lowered strength.

An example of constraint can be: P(C1)+P(C2)>P(C3)+P(C4). While it is noted that for a linear property such as average luminance, this equation can be written as P(C1 union C2)>P(C3 union C4) where there are only have two regions instead of four, this is generally not true for a non-linear property such as the maximum value of all coefficients. There are several different possible constraints depending on the bit to be embedded and the key used.

One advantage of the separation of the coefficients into four tiles is that, besides allowing for introducing constraints, it also allows the use of very low spatial frequencies. As explained above, these frequencies are robust to geometric attacks, while allowing for storing a higher number of bits than a method that would consider only a global property of the frame.

Coefficients LH and HL in the second method are used for video watermark embedding. There are various ways to manipulate these coefficients in order to insert constraints. A bit is embedded by inserting a constraint between coefficients LH and HL at the lowest level of resolution. For instance, the constraints can be such that for all x,y, in a frame f coefficients LH(x,y,f)>HL(x,y,f). As such a constraint is often too strong to be literally applied in practice, the coefficients can be manipulated such that the relationship globally applies. For instance, it can be such that:
Sum(x,y) LH(x,y,f)>Sum(x,y) HL(x,y,f).

### Or

Sum(x,y) (LH(x,y,f)>HL(x,y,f))

It should be noted that the second relationship is not linear, and allows for a finer grain but more complex insertion of constraints. This allows for distributing the change to coefficients such that areas more sensitive to changes not changed as much, if at all.

It should be noted that in this method instead of modifying pixel values, a relatively small number of coefficients (64×28 LL coefficients) are modified to change the luminance of a frame. This is a great advantage for watermark embedding, especially in an application, which has limited computational resources and requires cost-effective and real-time watermarking function.

Several more methods can be imagined, depending on the sets of coefficients, which can use coefficients in one frame only or coefficients from successive frames, the measured property, the type of relationship to enforce, etc. In general, the most workable methods will use sets of coefficients with mostly invariant properties, in the sense that the ordering of property values is generally preserved after modification to the content

For coefficient modification, the present invention in one embodiment uses two sets of coefficients C1={c11, . . . , c1N} and C2={c21, . . . , c2N}, and modifies their value. The values of coefficients cij, are denoted v(cij) and v′(cij) before, and after the modification respectively.

As discussed above, more than two sets of coefficients can be used for more sophisticated relationships. It is also possible to use just one set of coefficients. Without loss of generality, it may be desirable to set the relationship that P(C1)>P(C2)+r, where r is any value that adjusts the robustness of the relationship.

If function P is for instance the maximum, then to minimize the changes only manipulate the strongest coefficient of C1 and C2 in the following way:
If c1i=max{c11, . . . , c1N} then v′(c1i)=v(c1i)+a1, else v′(c1i)=v(c1i)
If c2j=max{c21, . . . , c2N} then v′(c2j)=v(c2j)+a2, else v′(c2j)=v(c2j)
With a1 and a2 such that v′(c1i)>v′(c2j)+r.

The function P above is strongly non-linear, i.e., the property does not vary smoothly as a function of the coefficients values. This method is advantageous because it allows embedding of a bit by modifying only one coefficient per set (albeit the change may have to be strong).

An extension of this ‘maximum’ method that can make it more robust, is to vary not only the maximum value but the N strongest values (with N typically significantly smaller than the size of the set of coefficients), to maximize the chance that the relationship is correctly decoded after manipulations to the content. It is understood that several other variations are possible to this technique.

On the other hand, if function P is a linear property of the coefficients (e.g. the average), the change can be distributed arbitrarily on all the coefficients in each set. Suppose, for example, that to set the relationship it is desirable to change the average value of coefficients such that:
avg{v′(c11), . . . , v′(c1N)}>avg{v′(c21), . . . , v′(c2N)}+r
   then if the change can be distributed equally on each coefficient (positively for coefficients belonging to C1 and negatively for coefficients belonging to C2), resulting in:
v′ (c1i)=v(c1i)+(r+avg{v(c21), . . . , v(c2N)}−avg{v(c11), . . . , v(c1N)})/N
   and similarly for c2j. If the relationship already holds, then (r+avg{v(c21), . . . , v(c2N)}−avg{v(c11), . . . , v(c1N)})<0 in which case the coefficients need not be modified.

As described above, the basic method can be extended to incorporate more relationships by using different properties. Consider, for example, the ‘maximum’ and ‘average’ methods together, to have four combinations of relationships between two sets, which allows for encoding two bits. Then, the following relationship may be enforced:

Max(C1)>max(C2) and avg(C1)<avg(C2)

Also, as described above, only one set of coefficients may have to be used, in which case the relationship is set against a fixed or pre-determined value. For instance, the relationship may be enforced such that the maximum or average of C1 is higher than a certain value. In another case, a key may be used to pseudo-randomly choose to enforce either a ‘maximum’ or an ‘average’ relationship depending on the key, which significantly enhances the security of the algorithm.

The above-described approach can incorporate a masking (perceptual) model, that allows for distributing the strength of the watermark in each region of the image resulting in a minimal perceptual impact of the watermark. Such model may also determine if a manipulation is possible in order to enforce a relationship without perceptual damage. The following describes non-limiting ways to incorporate a masking model for video content in the context of real-time watermarking in a digital cinema projector.

There are two main masking effects for images: texture masking and brightness masking. Furthermore, videos benefit from a third masking effect: temporal masking.

In some applications such as digital cinema, which has limited computational resources but requires real-time watermarking, it can be desirable to only exploit the LL, LH, HL and HH subband coefficients of the lowest resolution level, e.g., at the resolution level 5. The last three types of coefficients are potential indicators of texture while LL is an indicator of brightness. However, the corresponding resolution is low, and at this resolution the texture masking effects are not significant. To illustrate this, let us compare a video frame at full resolution, and the same video frame reconstructed from coefficients at resolution level 5. See FIG. 5. It seems that most of the texture is lost at this resolution. Therefore, the LH, HL and HH subband coefficients for level 5 are poor indicators of texture, and will not be used measure texture masking.

However, temporal masking can still be estimated with a fairly good precision, as movement is generally applied to rather large areas of the video, which are therefore of low frequency. Temporal masking can be measured by subtracting coefficients of the previous frame from coefficients of the current frame. C(f,c,l,b,x,y) denotes the coefficient of frame f, channel (i.e. color component) c, resolution level 1, subband b (b=0 to 3 for coefficients LL, LH, HL and HH), position x,y. Thus, the sum of the absolute difference between coefficients of the same type on two successive frames is a valid measure of temporal change:
T(f,c,l,b,x,y)=avg(c=1 . . . 3)sum(b=0.3)(abs(C(f,c,l,b,x,y)−C(f l,c,l,b,x,y))

For a given frame f, resolution level 1=5, T(f,c,l,b,x,y) is measured for all positions (x,y) and for each of the colour channels (there are typically three color channels/components). If there are several channels, it can be advantageous to take the average value of T(f,c,l,b,x,y) over all channels. Then for each position (x,y), the value of T(f,c,l,b,x,y) is compared to a threshold t, and the coefficients at this position are modified only if the value is higher than t. Experimentally, a good value for t is 30. If coefficients are changed, the amount of change can be made as a function of the luminance, as is known in the prior art.

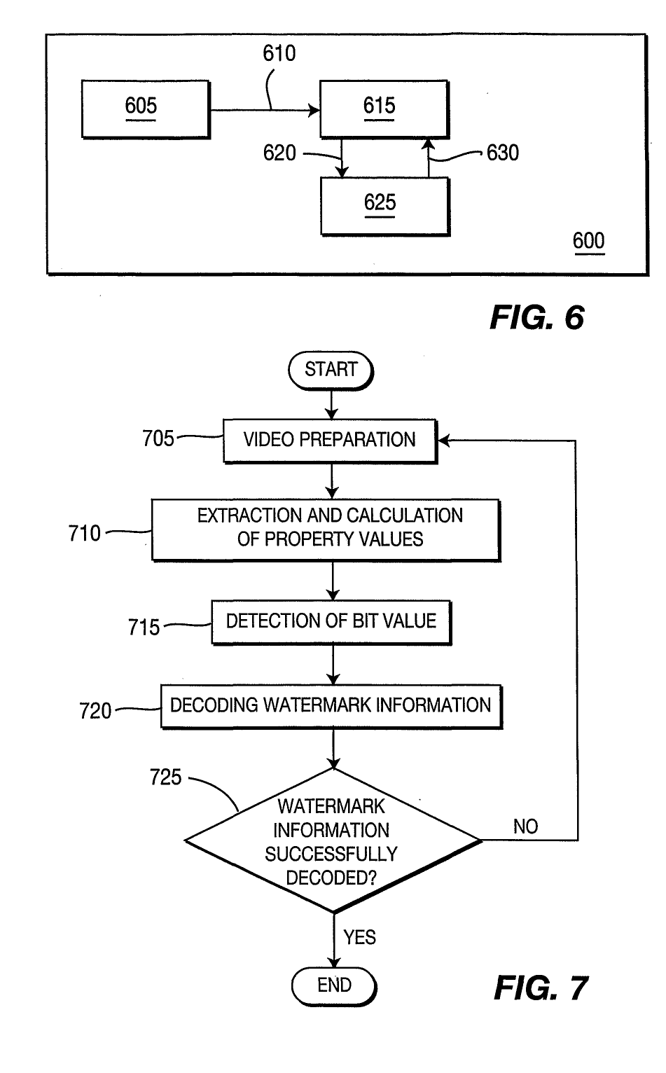

FIG. 6 is a block diagram of watermarking in a D-Cinema server (Media Block). Media Block 600 has modules, which may be implemented as hardware, software firmware etc. for performing watermarking including at least watermark generation and watermark embedding. Module 605 performs watermark generation including payload generation. Encoded watermark 610 is then forwarded to watermark embedding module 615, which receives the coefficients of the image from J2K decoder 625 and then selects and modifies wavelet coefficients 620, and finally returns the modified coefficients to J2K decoder 625.

As described above, a watermark generation module produces the payload, which is a sequence of bits to be directly embedded. The watermark embedding module takes the payload as input, receives the wavelet coefficients of the image from a J2K decoder, select and modify the coefficients, and finally returns the modified coefficients to the J2K decoder. J2K decoder continues to decode the J2K image and output the decompressed image. As an alternative design, watermark generation module and/or watermark embedding module can be integrated into the J2K decoder.

The watermark generation module can be called periodically (e.g. every 5 minutes) in order to update the timestamp in the payload. Therefore, it can be called “off-line”, i.e. a watermark payload may be generated in advance in the D-Cinema Server. In any case, its computational requirements are relatively low. However, the watermark embedding must be performed in real-time and its performance is critical.

The video watermark embedding can be done with various levels of complexity in the way the original content is taken into consideration. More complexity may mean additional robustness for a given fidelity level or more fidelity for the same robustness level. However, it comes with an additional cost in terms of the amount of computation.

Before estimating the number of required operations for video watermark embedding, it is noted that any of the following basic computational steps are considered one operation:

Bit shifting of coefficient

Addition or subtraction of two coefficients

Multiplication of two integer numbers

Comparison of two coefficients

Accessing a value in a lookup table

In the following example, C(f,c,l,b,x,y) and C′(f,c,l,b,x,y) are the original coefficient and watermarked coefficient at position x (width),y (height) for the frequency band b (0: LL, 1: LH, 2:HL, 3:HH) at the wavelet transformation level 1 for color channel c for frame f, respectively. Furthermore, it is assumed that N is the number of coefficients at the lowest resolution level, which need to be modified.

For the sake of simplicity, it is assumed in the following that a coefficient value is increased during video watermark embedding. However, it is noted that in equations an addition could equally be replaced by a subtraction.

If each coefficient is changed by the same amount, then there is, therefore, only one operation per coefficient:
C(f,c,l,,b,x,y)=C(f,c,l,b,x,y)+a
   where the value a is a constant number. One additional comparison operation may be required to check the overflow of the modified coefficient. Thus, the total computation requirement would be 2*N.

However, the above is not an effective method. Indeed, if the constant value a is too large, the watermark will become visible. Therefore, the value a must be conservative, i.e. it must be low enough such that the watermark will never result in visible artefacts, but on other hand if the video watermark is too conservative, it may not survive serious attacks. The LL subband coefficient corresponds to local luminance, while LH, HL and HH coefficients correspond to image variations, or “energy”. It is well known that the human eye is less sensitive to changes in luminance in bright areas (stronger LL coefficient). It is also less sensitive to changes in area with strong variations, which, depending on the direction of the variation, depend on coefficients LH, HL and HH. This however should be considered carefully: LH and HL coefficients may correspond to perceptually significant changes such as edges, which have to be manipulated with care.

Nevertheless, it can be advantageous to make a modification that is proportional to the coefficient, at least for coefficients LL and HH. A simple proportional modification can be done by copying the original coefficient, bit-shifting the copied coefficient, and adding or subtracting the bit-shifted coefficient, e.g.

C′(f,c,l,b,x,y)=C(f,c,l,b,x,y)+bitshift(C,n)

A typical value for n would be 7 or 8. For n=7 or 8, the coefficient is modified by 1/128 or 1/256 of its original magnitude. For example, for an image with an average luminance of 128 on a scale of 0 to 255, the impact of the coefficient modification would be a change of luminance of 1. Such a change typically does not create visible artefacts.

There are two operations per coefficient. With the possible overflow checking, the total computation requirements would be 3*N where N is the number of manipulated coefficients.

It is also noted that it is possible to impose a minimum change a, to make sure that for frames with very low luminance the watermark is sufficiently strongly embedded. In this case there are three operations per coefficient: C′(f,c,l,b,x,y)=C(f,c,l,b,x,y)+max(bitshift (C,n),a).

Additionally, the following perceptual features can be used to make adaptive changes on coefficients:
Temporal context. Temporal masking is related to temporal activity, which is best estimated by using coefficients in the previous, current and following frames. the present invention uses only coefficients of the preceding and current frame to measure temporal activity. A high temporal activity allows for a stronger watermark. The estimated computational complexity for temporal modelling is about four.
Texture context. For each coefficient C(f,c,b,l,x,y), K additional corresponding coefficients in other subbands may be used to model the texture and flatness, with an estimated complexity of 4K² operations.
Luminance context. A lookup table can be used to determine weight according to the luminance at the coefficient C(f,c,b,l,x,y). The estimated operation is B where B is the number of bits representing the luminance value.

All perceptual features can be weighted and balanced to determine the modification of the coefficient:

### C(f,,c,b,l,x,y)′=C(f,c,b,l,x,y)*(1+W)

where W is the weight combining all perceptual features.

Rough estimates of watermark embedding complexity, where for convenience complexity is estimated in terms of number of operations as described above. It should be noted that the number of operations can vary according to the exact way an operation is defined, the implemented watermarking and masking procedure, etc. Nevertheless, it can be concluded that, given the relatively small number of coefficients which need to be accessed by the method of the present invention (on the order of 1/1000 of an image size), and the relatively small number of operations per coefficient, the method of the present invention is robust and computationally feasible.

Referring now to FIG. 7, watermark detection generally consists of four steps: video preparation 705, extraction and calculation of property values 710, detection of bit values 715, and decoding of embedded (watermark) information 720. A test is performed at 725 to determine if the watermark information has been successfully decoded. If the watermark information has been successfully decoded then the process is complete. If the watermark information has not been successfully decoded then the above process can be repeated.

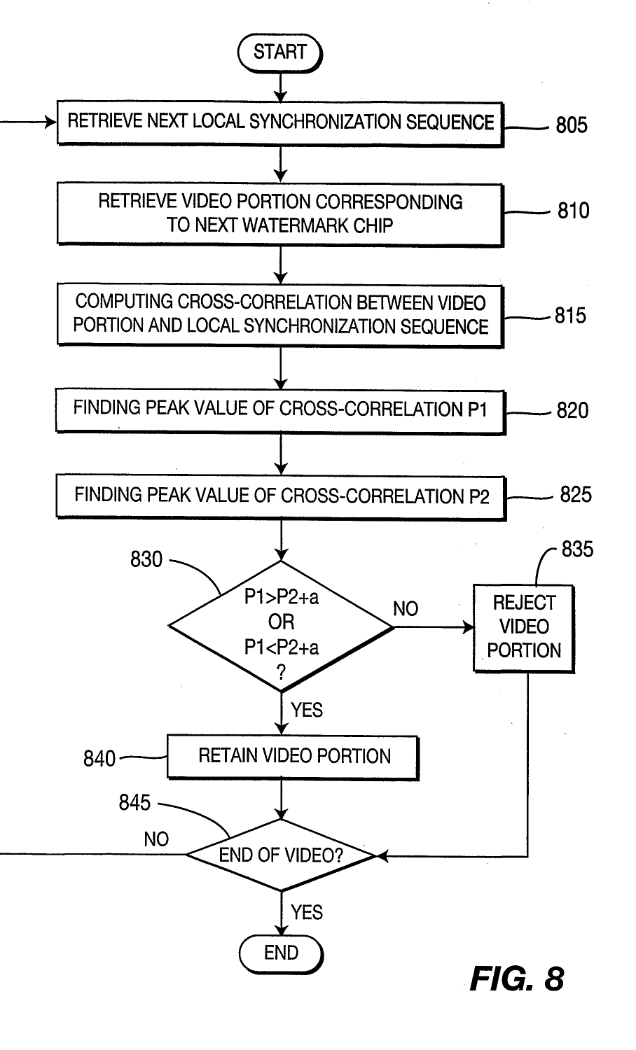

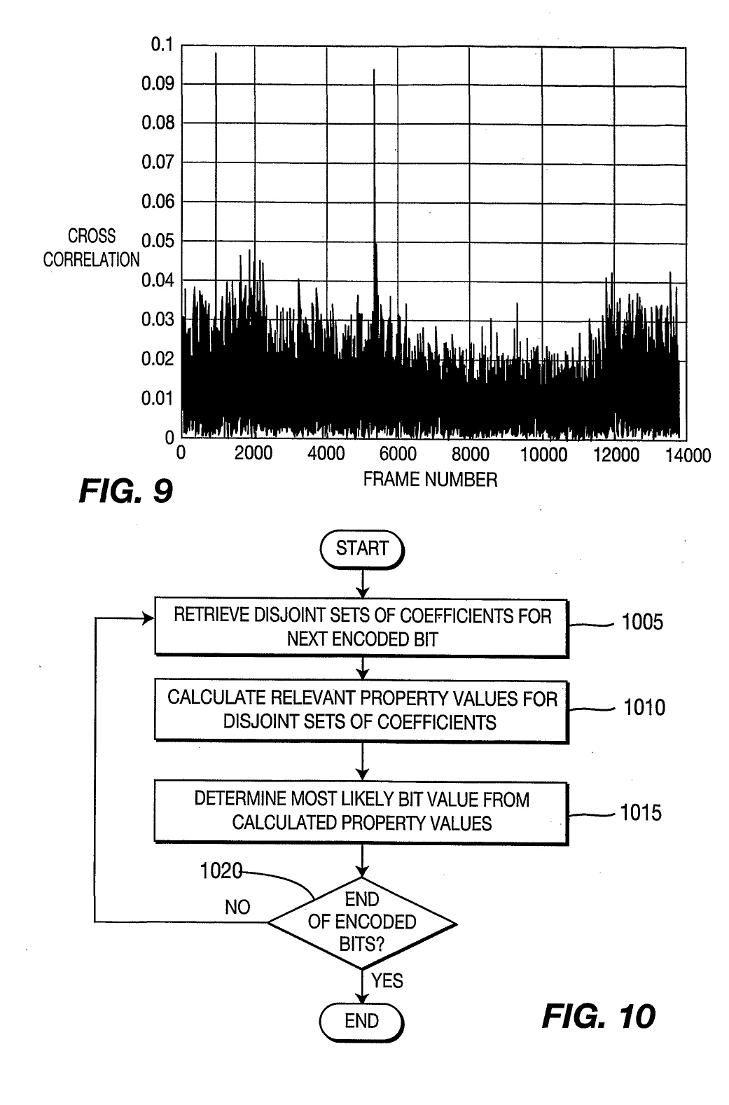

Video preparation itself includes scaling or re-sampling of the video content, synchronization of the video content and filtering:
Re-sampling of the transformed (distorted) video may have to be done if the frame rate is different at embedding and detection. This is often the case, as the frame rate for embedding is 24, while it can be e.g. 25 (PAL SECAM) or 29.97 (NTSC) at detection. Re-sampling is performed using linear interpolation. The output is the resampled video.
Filtering the resampled video, typically with a high-pass temporal filter to diminish the noise due to the cover content and to emphasize the watermark. The output is the filtered video.
Synchronization of the filtered video can be done either with the original content using a variety of methods as described above, or by cross-correlation with synchronization bits if they were embedded in the video content. Typically, only a temporal registration would have to be done, if very low spatial frequencies are used. The global synchronization unit, optionally assembled together with the local synchronization units, is used for determining the starting point of the watermark sequence. A cross-correlation is performed between the filtered video and the known synchronization bits. There is typically a strong peak in the cross-correlation function for a corresponding shift of the video. Referring now to FIG. 8, the local synchronization process retrieves the next local synchronization sequence/unit at 805. The video portion corresponding o the next watermark chip is retrieved at 810. The video portion and the local synchronization sequence/unit are cross-correlated at 815. A peak value of cross-correlated property value P1 is located at 820 and a peak value of property value P2 is located at 825. A test is made at 830 to determine if property value P1 is greater than property value P2 plus a pre-determined value or if property value P1 is less than property value P2 plus a pre-determined value. If the test results are negative then the video portion is rejected at 835. If the test results are positive then the video portion is retained at 840. A further test is performed at 845 to determine if the end of the video has been reached. If the end of the video has been reached then the local synchronization process is done. If the end of the video has not been reached then the local synchronization process is repeated. FIG. 9 shows a cross-correlation function (actually a low pass filtered version of the magnitude) with two peaks indicating the starting point of two successive watermark chips. Once the starting point of the watermark chip is located, the local synchronization units that are placed at the beginning of each payload are used for slight realignment of the video at regular intervals. In turn, each of the 12 local synchronization units is cross-correlated with the filtered video in a small window around the expected position. If a comparatively strong correlation peak is found (as measured by the difference between the highest peak and the second highest peak), the adjacent filtered video is kept for next step, otherwise it is discarded. The rationale is that a stronger correlation peak is an indicator that the filtered video is more precisely synchronized. The output of this step is the synchronized video.

The output of the three steps of the video preparation will be denoted ‘processed video’ in the following. A processed video is a set of data, which is computed from the received video in order to facilitate extraction/calculation of the property value, which is the next step of watermark detection.

In one embodiment of watermark embedding as previously described, the average luminance of each of the four quadrants is computed for each frame. The property values form a vector number of frames×4. For wavelet watermark embedding using LL subband watermarking, the property values can be extracted whether from a wavelet or a baseband representation of the received video. For both cases, a processed video of size number of frames×4 is obtained. In both of the above schemes the frames are separated into four parts/tiles from a central point. While this central point can be automatically set to the center point of the frame—as it is in the original video—it naturally has some offset in a camcorder captured video.

Extracting and computing the property values for wavelet watermark embedding using LH and HL subbands works slightly differently. Modifying LH coefficients creates stripes (stripes are equally spaced horizontal lines in the baseband video) with a frequency that can be precisely determined, at least in the watermarked video before any attack. The stripes are not visible when the watermark energy is adjusted using a masking model as described above. One can therefore compute the transformed video by measuring the energy in that frequency (e.g. using a Fourier transform). However, during a camcorder attack and subsequent cropping of the video, the relevant frequency can be shifted, and its energy spread on neighbouring frequencies. Therefore, the energy signal for all frames is collected in a 5×5 window around the relevant frequency. Each of these 25 signals is tested for a cross-correlation peak with the synchronization bit sequence, and the one with the highest peak is output as the property values.

In watermark detection phase, property values are calculated corresponding to how the watermark is embedded. The watermark can be embedded by enforcing at least the following relationships between and/or among:
property values of consecutive frames;
one property value of a region of a frame and a pre-determined value;
property values of one region of a frame and another region of the same frame
property values of one region of a frame and the corresponding region of the consecutive frame

As a property value can also be the coefficient value itself, the watermark can be embedded by enforcing at least the following relationships between and/or among:
one coefficient value in a video volume and a pre-determined value;
one coefficient value in one subband of a frame and the other coefficient value at the corresponding position and subband of a consecutive frame;
one coefficient value in one subband of a frame and another coefficient value at another sub-band of the same frame
   Property values can be calculated in the baseband and/or in the transform domain. Analogous to watermark embedding, multiple bits can be detected from the multiple relationships between and/or among multiple property values.

The first step and the second step of watermark detection can be interchanged in terms of order. For convenience, it is advantageous if possible to compute the property values first because it results in data compaction (i.e., reduce the entire image data of each frame to a few values per frame), which can be fit into a form from which the watermark can be more easily read. However, it may not always be possible to perform the computation of property values first because of serious distortion of the video, especially geometric distortion.

The third step receives the property values as input, and outputs the most likely bit value for each of the 127 encoded bits. The property values may correspond to multiple insertions of each of the encoded 127 bits. In an example in accordance with the principles of the present invention, in which each bit is inserted at 12 different locations, there can be up to 12 insertions, but less if certain payload units have been discarded because of a bad local synchronization.

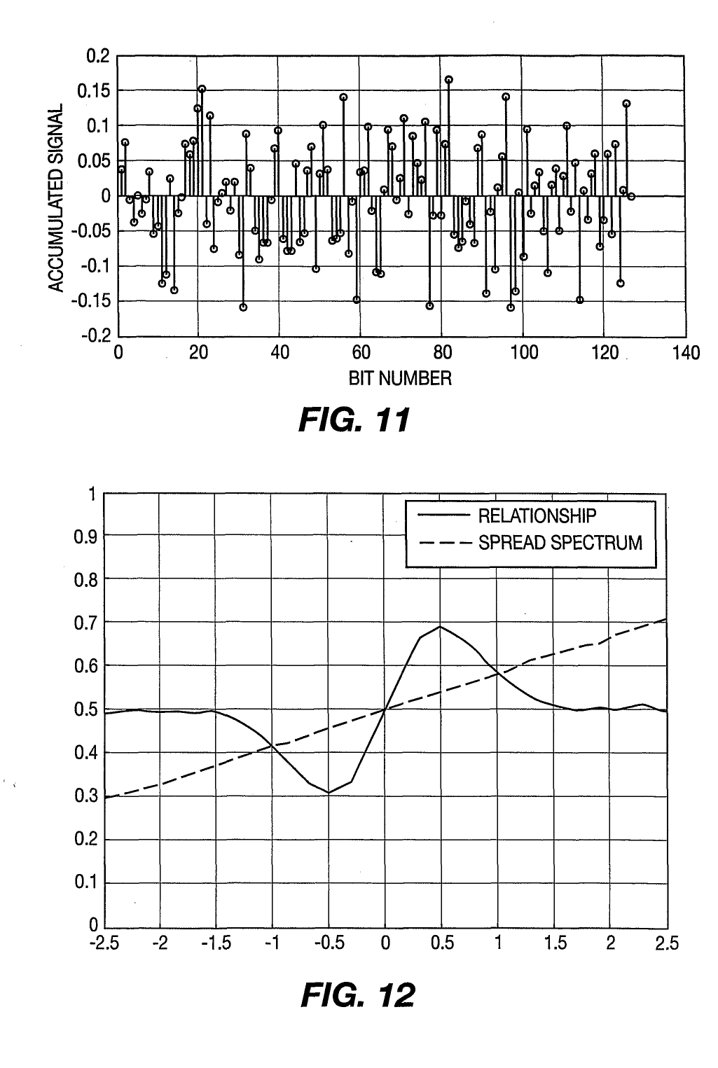

Referring now to FIG. 10, disjoint sets of coefficients are retrieved for a next encoded bit at 1005. At 1010, relevant property values are calculated for the disjoint sets of coefficients. The most likely bit value is determined from the calculated property values at 1015. A test is performed at 1020 to determine if there are any more encoded bits. If there are any more encoded bits then the above process is repeated. An exemplary accumulated signal is depicted in FIG. 11.

Each bit of the encoded payload has been expanded, encrypted and inserted at multiple locations in the content. For each of the expanded bits, as described above, insertion is typically done by setting a constraint between the property values of two sets of coefficients C1 and C2, e.g. P(C1)>P(C2). Suppose there are N such expanded bits and therefore N such inserted constraints, then:

Bit=1 if P(C1i)>P(C2i) for each i where 1≦i≦N

Bit=0 if P(C1i)<P(C2i) for each i where 1≦i≦N

In general, because of channel noise or the initial impossibility in establishing the relationship, all the relationships will not necessarily coincide with the inserted bit. The simplest approach to solve this problem would be to take a “majority vote”. That is, to select the bit whose corresponding relationships between coefficients are observed the most often.

Bit=1 if the number of cases where P(C1i)<P(C2i) (1≦i≦N) is greater than N/2

Bit=0 otherwise

This approach does not help to resolve cases where N is even, and the number of relationships for bit=1 and bit=0 are equal. Furthermore, this approach does not take full advantage of the information of P(C1), P(C2), and possibly other information that may increase the likelihood of correctly determining the relationship. A more refined approach consists of estimating a probability that the inserted bit value is 1, respectively 0, given the observation of property values P(C1i) and P(C2i). The individually estimated probabilities are combined using a probabilistic approach, and decision is made based on the Maximum-Likelihood (ML) criterion, where the most probable bit is selected. Other criteria are possible, such as the Neyman-Pearson rule.

Using the ML rule, where the most probable bit is selected, the decision is based only on the property values. Then the ML rule states:

### If: Prob(Bit=1; P(C11), P(C21), . . . , P(C1N),P(C2N))>

Prob(Bit=0; P(C11), (C21), . . . , P(C1N), P(C2N)) Then bit=1
Using Baye's rule, and assuming that each bit value is equi-probable, this can be rewritten as: Prob (P(C11), P(C21), . . . , P(C1N), P(C2N); bit=1)>
Prob((C11), P(C21), . . . , P(C1N), P(C2N); bit=0)

As the bit is expanded at different pseudo-random locations in the content, it can be assumed that the property values are relatively independent. That is,

for i=1, . . . , N Prob(P(C1i), P(C2i); bit=1)/Prob(P(C1i), P(C2i); bit=0)>1
Taking the logarithm:
Sum I=1, . . . , N (log(Prob(P(C1i), P(C2i); bit=1)−log(Prob(P(C1i), P(C2i); bit=0)))>0

To implement this equation, the equations Prob (P(C1i,P(C2i); bit=1) and Prob (P(C1i,P(C2i); bit=1) need to be derived. These equations will depend on the properties of the channel. The general technique consists of collecting enough data for estimating this function. Some a priori knowledge, or assumptions on the probability model (e.g. that the coefficients or the noise follow a Gaussian distribution) can be used.

Consider the very specific case where the logarithm of the probability is proportional to the difference between P(C1i) and P(C2i), symmetrically for bit 1 and bit 0:

Log(a1*Prob(P(C1i), P(C2i); bit=1))=a2*(P(C1i)−P(C2i))
Log(a1*Prob(P(C1i), P(C2i); bit=0))=−a2*(P(C1i)−P(C2i))
Then the rule becomes:
Sum I=1, . . . , N 2*a2((P(C1i)−P(C2i)))>0

### Or

Sum I=1, . . . , N P(C1i)>Sum I=1, . . . , N P(C2i)

The rule derived for this specific case corresponds to a simple correlation, similarly to what is used in spread spectrum system. This rule is, however, suboptimal because in general the probability will not vary in a logarithmic way to the difference. This is one reason why the method of the present invention can be seen as more general, and more effective than spread spectrum based methods.

In fact, because of the specific way in which constraints are inserted, i.e. depending on the original content values, it turns out that the probability is generally not a monotonically increasing function. To illustrate that, the following simulation was performed in which the estimate of a bit value was compared based on the observation of a received signal, for respectively the relationship-based approach of the present invention and a classic spread spectrum approach.

The original content Gaussian noise X was generated. A binary watermark W was added to this signal taking its value in [−1, +1]. The binary watermark was added first following the constraint-based concept in the following way:

If X>a1, Y=X
If X<a2, Y=X

### Else Y1=X+r*W

The values a1=0.5, a2=−0.5, r=0.3 were chosen. This resulted in a PSNR of −15 dB.

Then a spread-spectrum watermark was added to the generated signal in the following way:

Y2=X+a*W

The parameter ‘a’ was adjusted to result in the same PSNR of −15 dB.

The same noise vector N was added to the two signals Y1 and Y2, to get 2 received signals R1=Y1+N and R2=Y2+N. The noise also had a PSNR of −10 dB with respect to the original content. For the two received contents R1 and R2, the probability that the embedded bit was ‘1’ given the received signal value was estimated. The results are plotted in the graph depicted in FIG. 12. The difference is striking: as expected, for the spread-spectrum embedding, the estimated probability that the bit is 1 increases linearly with the received signal value. However, for the relationship-based approach of the present invention, the estimated probability has a very specific shape going through a minimum then a maximum. This shape can be explained as follows:
When the cover content has a high or low value, it is most likely not used for embedding, therefore it is logical that the received signal is uncorrelated to the bit
The estimate is most reliable at −0.5 and +0.5, which are the minimum/maximum values at which the watermark is embedded
   It can, therefore, be concluded that the correct estimate of the probability is of significant importance to the proper working of the method of the present invention.

In the last step, once the 127 bit values of the encoded payload are estimated, the 64 bit payload can be decoded, using the BCH decoder. With such a code, up to 10 errors can be detected from the estimated encoded payload. As described above, this payload contains various information for forensic tracking such as the location/projector identifier and timestamp in a digital cinema application. This information is extracted from the decoded payload and allows for a wide range of uses such as forensic tracking down the potential fraud that occurred.

In case of a failure in the last step (i.e. no valid watermark information is decoded), the above four steps can be repeated with a different strategy (e.g. optimized synchronization and registration for the video in the first step) for each step until a watermark information is successfully decoded or reaching a maximum number of such trials.

It is to be understood that the present invention may be implemented in various forms of hardware (e.g. ASIC chip), software, firmware, special purpose processors, or a combination thereof, for example, within a server or mobile device. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such 10, as an additional data storage device and a printing device.

It is to be further understood that, because some of the constituent system components and method steps depicted in the accompanying figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

1. A method for embedding a watermark by enforcing relationships between property values of selected sets of coefficients within a volume of video, said method comprising:
generating a payload;
selecting coefficients;
modifying coefficients, wherein said modified coefficients replace said selected coefficients; and
embedding said watermark into said volume of video.

2. The method according to claim 1, wherein a property is a measurable feature of any portion in a volume of video.

3. The method according to claim 1, wherein said property values are calculated by one of averaging, determining a maximum and determining a minimum.

4. The method according to claim 1, wherein coefficient modification is performed in one of a spatial domain and a transform domain in order to enforce said relationships between said property values.

5. The method according to claim 1, wherein a bit of said payload are embedded by enforcing one relationship between or among property values of at least two of said selected sets of coefficients.

6. The method according to claim 1, wherein a bit of said payload are embedded by enforcing one relationship between one of said property values of one of said selected set of coefficients and a predefined value.

7. The method according to claim 1, wherein multiple bits of said payload are embedded by enforcing multiple relationships between or among property values of at least two of said selected sets of coefficients.

8. The method according to claim 1, wherein multiple bits of said payload are embedded by enforcing multiple relationships between or among property values of at least two of said selected sets of coefficients.

9. The method according to claim 1, wherein said modifying step further comprises establishing a constraint-based relationship between property values of said selected sets of coefficients, based on a key and said payload to be inserted into said volume of video, and further wherein said selected sets of coefficients are disjoint.

10. The method according to claim 9, wherein said relationship is an inequality between said values of said property of said selected disjoint sets of coefficients.

11. The method according to claim 10, further comprising:
selecting a value, r; and
adding said value, r, to one of said property values of said selected disjoint sets of coefficients in order to enforce said inequality relationship.

12. The method according to claim 10, wherein if said inequality relationship is in place, no modification of said property values of said selected disjoint sets of coefficients is performed.

13. The method according to claim 10, wherein if an opposite inequality relationship exists and modification of said property values of said selected disjoint sets of coefficients will introduce perceptual damage, no modification is performed.

14. The method according to claim 10, wherein said property values of said selected disjoint sets of coefficients are modified to enforce said inequality relationship.

15. The method according to claim 10, wherein said property values of said selected disjoint sets of coefficients are modified proportionally to enforce said inequality relationship.

16. The method according to claim 15, further comprising:
copying one of said property values of said one of said selected disjoint sets of coefficients;
bit-shifting said copied property value of said one of said selected disjoint sets of coefficients; and
adding said bit-shifted copied property value of said one of said selected disjoint sets of coefficients to said property value of said one of said selected disjoint sets of coefficients.

17. The method according to claim 15, further comprising:
copying said property values of said selected disjoint sets of coefficients;
bit-shifting said copied property values of said selected disjoint sets of coefficients; and
adding said bit-shifted copied property values of said selected disjoint sets of coefficients to corresponding property values of said one of said selected disjoint sets of coefficients.

18. The method according to claim 9, wherein said constraint-based relationship is linear.

19. The method according to claim 9, wherein said constraint-based relationship is non-linear.

20. The method according to claim 9, wherein said constraint-based relationship is an average value of said property value of said disjoint sets of coefficients and wherein said property value of a first of said disjoint sets of coefficients are positively modified and said values of said property of a second of said disjoint sets of coefficients are negatively modified.

21. The method according to claim 9, wherein said constraint-based relationship is temporally masked.

22. The method according to claim 1, wherein said coefficients are minimally modified.

23. A system for embedding a watermark by enforcing relationships between property values of selected sets of coefficients within a volume of video, said method comprising:
means for generating a payload;
means for selecting coefficients;
means for modifying coefficients, wherein said modified coefficients replace said selected coefficients; and
means for embedding said watermark into said volume of video.

24. The system according to claim 23, wherein a property is a measurable feature of any portion in a volume of video.

25. The system according to claim 23, wherein said property values are calculated by one of averaging, determining a maximum and determining a minimum.

26. The system according to claim 23, wherein coefficient modification is performed in one of a spatial domain and a transform domain in order to enforce said relationships between said property values.

27. The system according to claim 23, wherein a bit of said payload are embedded by enforcing one relationship between or among property values of at least two of said selected sets of coefficients.

28. The system according to claim 23, wherein a bit of said payload are embedded by enforcing one relationship between one of said property values of one of said selected set of coefficients and a predefined value.

29. The system according to claim 23, wherein multiple bits of said payload are embedded by enforcing multiple relationships between or among property values of at least two of said selected sets of coefficients.

30. The system according to claim 23, wherein multiple bits of said payload are embedded by enforcing multiple relationships between or among property values of at least two of said selected sets of coefficients.

31. The system according to claim 23, wherein said means for modifying further comprises means for establishing a constraint-based relationship between property values of said selected sets of coefficients, based on a key and said payload to be inserted into said volume of video and further wherein said selected sets of coefficients are disjoint.

32. The method according to claim 31, wherein said relationship is an inequality between said values of said property of said selected disjoint sets of coefficients.

33. The system according to claim 32, further comprising:
means for selecting a value, r; and
means for adding said value, r, to one of said property values of said selected disjoint sets of coefficients in order to enforce said inequality relationship.

34. The system according to claim 32, wherein if said inequality relationship is in place, no modification of said property values of said selected disjoint sets of coefficients is performed.

35. The system according to claim 32, wherein if an opposite inequality relationship exists and modification of said property values of said selected disjoint sets of coefficients will introduce perceptual damage, no modification is performed.

36. The system according to claim 32, wherein said property values of said selected disjoint sets of coefficients are modified to enforce said inequality relationship.

37. The system according to claim 32, wherein said property values of said selected disjoint sets of coefficients are modified proportionally to enforce said inequality relationship.

38. The system according to claim 37, further comprising:
means for copying one of said property values of said one of said selected disjoint sets of coefficients;
means for bit-shifting said copied property value of said one of said selected disjoint sets of coefficients; and
means for adding said bit-shifted copied property value of said one of said selected disjoint sets of coefficients to said property value of said one of said selected disjoint sets of coefficients.

39. The system according to claim 37, further comprising:
means for copying said property values of said selected disjoint sets of coefficients;
means for bit-shifting said copied property values of said selected disjoint sets of coefficients; and
means for adding said bit-shifted copied property values of said selected disjoint sets of coefficients to corresponding property values of said one of said selected disjoint sets of coefficients.

40. The system according to claim 31, wherein said constraint-based relationship is linear.

41. The system according to claim 31, wherein said constraint-based relationship is non-linear.

42. The system according to claim 31, wherein said constraint-based relationship is an average value of said property value of said disjoint sets of coefficients and wherein said property value of a first of said disjoint sets of coefficients are positively modified and said values of said property of a second of said disjoint sets of coefficients are negatively modified.

43. The system according to claim 31, wherein said constraint-based relationship is temporally masked.

44. The system according to claim 23, wherein said coefficients are minimally modified.
